(19) United States
(12) Patent Application Publication
(10) Pub. No.: US 2010/0253453 A1
(43) Pub. Date: Oct. 7, 2010

(54) COIL FOR ELECTROMAGNET

(76) Inventor: Young guk Kim, Daegu (KR)

Correspondence Address: CHRISTOPHER PAUL MITCHELL, 888 16TH ST., NW, SUITE 800, WASHINGTON, DC, 20006, US

(21) Appl. No.: 12/599,297

(22) PCT Filed: Jun. 21, 2007
(86) PCT No.: PCT/KR07/03005

§ 371 Date: Nov. 8, 2009

(30) Foreign Application Priority Data
May 8, 2007 (KR) 10-2007-0044631

(51) Int. Cl. H01F 5/00

(52) U.S. Cl. 335/299

(57) ABSTRACT

A coil for an electromagnet used in a clutch for a compressor of a vehicle is disclosed. The coil consists of a plurality of aluminum wires coated with an insulator and wound around a bobbin, in which the plurality of wires are simultaneously wound around the bobbin, and the wound wires are connected in parallel with each other. As compared with a copper wire, although a volume of the aluminum wires is increased, the whole resistance value is low, and thus, the heating value is reduced. Since the heating value of the aluminum wires is equal, the electromagnet has the same performance in a saturation state.

### TECHNICAL FIELD

The present invention relates to a coil for an electromagnet used in a clutch of a compressor of a vehicle.

### BACKGROUND ART

In general, a vehicle is provided with an air conditioner designed to extract heat from an indoor space using a refrigeration cycle. The air conditioner includes a compressor for compressing a heat exchange medium at high temperature and high pressure and discharging the compressed heat exchange medium refrigerant to a heat exchanger to cool the indoor space of the vehicle.

The compressor is driven by a driving force of an engine of the vehicle, and includes a clutch for transmitting the driving force of the engine to the compressor or interrupting the transmission of the driving force to the compressor. More specifically, if the clutch is driven, the driving force of the engine is transmitted to the compressor. Meanwhile, if the clutch is not driven, the driving force of the engine is not transmitted to the compressor to stop operation of the compressor.

FIG. 1 is a partially cross-sectional view illustrating the construction of the clutch provided in the compressor. Reference numeral 100 indicates a compressor body. A pulley 102 is rotatably mounted on a rotary shaft 100a of the compressor body 100 through a bearing. The pulley 102 is coupled to the engine via a belt (not shown), so that if the engine is driven, the pulley 102 is rotated.

An electromagnet 104 is positioned in the pulley 102 and is fixed to the compressor body 100. The pulley 102 is provided with a frictional surface 102a on a front side thereof.

A hub 106 is fixed to an end of the rotary shaft 100a of the compressor body 100, and a stopper plate 108 is attached to the front side of the hub 106. A disc 110 is installed on the rear side of the stopper plate 108 so that the stopper plate 108 is spaced apart from the frictional surface 102a of the pulley 102 at a certain interval.

If the electromagnet 104 fixed to the compressor body 100 is applied with a certain voltage, a magnetic force is generated by the electromagnet 104, and the disc 110 comes into closely contact with the frictional surface 102b of the pulley 102. At that time, a leaf spring having one end fixed to the disc 110 and the other end positioned between the hub 106 and the stopper plate 108 has a restoring force.

As the disc comes into contact with the frictional surface 102b of the pulley 102, the rotation force of the pulley rotated by the engine of the vehicle is transmitted to the rotary shaft 100a of the compressor through the frictional force between the disc 110 and the frictional surface 102b of the pulley 102 thereby to drive the compressor body 100.

If the voltage is not applied to the electromagnet 104, the magnetic force is eliminated, and the disc 110 is detached from the frictional surface 102b of the pulley 102 by the restoring force of the leaf spring. Thus, the rotation force of the pulley 102 is not transmitted to the rotary shaft 100a of the compressor body 100, and the pulley 102 is idled.

In the clutch, the electromagnet 104 includes, as shown in FIG. 2, a bobbin 300 of a coil housing made of insulated plastic, and a wire 302 made of good conductivity and coated with insulation, such as enamel. The coated copper wire is spirally wound around the bobbin 300 for a certain number of turns.

The electromagnet 104 is wound with the copper coil having good electrical conductivity. Since the copper is expensive, the cost of the clutch for the compressor is raised.

More specifically, metals having electrical conductivity may be enumerated as silver, copper, gold, aluminum, magnesium, zinc, iron, lead, and antimony in lower order. Silver has the highest electrical conductivity, but the silver is very expensive relative to copper.

The coil for the electromagnet 104 is made by using the copper wire having the good electrical conductivity next to the silver and low specific resistance and exothermicity.

In Korea, the most of copper depends on importation. In case of increased demand of copper or violent price fluctuation in metal markets, the price of the copper is risen, and thus, the manufacturing costs of the electromagnet coil using the copper wire and the clutch for the compressor are accordingly increased.

In order to solve the cost problem associated with the copper wire for the electromagnet coil, however, aluminum which is inexpensive relative to copper is used as the coil for the electromagnet.

If the aluminum wire is used as the coil, the electromagnet can be inexpensively manufactured in comparison with the electromagnet using copper. Since aluminum has electrical conductivity lower than copper, if the aluminum wire is used, the number of the turns should be increased so that the electromagnet generates a magnetic force of the same intensity, as compared with the electromagnet using the copper wire. Consequently, there is a problem in that the volume of the electromagnet is increased.

More specifically, in case the electromagnet is manufactured by winding the aluminum wire around the bobbin, in which the wire has the same diameter as that of the copper wire and is wound for the same number of turns as that of the copper wire, when the voltage of the same level is applied to the electromagnet, an amount of a current flowing in the aluminum wire is lower than a current flowing in the copper wire. The reason is that the electrical conductivity of the aluminum is lower than that of the copper. Consequently, the magnetic force generated from the electromagnet using the aluminum wire is lower than that generated from the electromagnet using the copper wire.

In order to provide the electromagnet using the aluminum wire with the same magnetic force as that generated from the electromagnet made of the copper wire, therefore, the aluminum wire should be wound around the bobbin for the number of turns more than about 40% in comparison with the number of turns of the copper wire. Thus, the volume of the electromagnet using the aluminum wire is larger than that of the electromagnet using the copper wire.

The voltage induced by the coil of the electromagnet can be expressed by Equation 1 below.

$$V = L \frac{d B}{d t} \qquad Equation 1$$

herein, V is a voltage, L is inductance of the electromagnet coil, and B is flux density.

In Equation 1, in order to increase the voltage induced by the coil of the electromagnet, the inductance of the electromagnet coil should be increased, and the inductance of the electromagnet coil will be increased as the number of turns is large.

In case the electromagnet coil uses the aluminum wire in place of the copper wire, the volume of the electromagnet coil is increased, and thus, the volume of the clutch for the compressor is also increased.

As the price of copper is rising in recent years, manufacturing the electromagnet by using the aluminum wire has been continuously developing. Also, it has been trying to find a measure for solving the problem in that the volume is increased when the aluminum wire is used.

For example, technique to modify the clutch of the compressor has been proposed, so as to solve the problem of increasing the volume in case the aluminum wire is used, as compared with the copper wire.

### DISCLOSURE OF INVENTION

### Technical Problem

However, the modified clutch of the compressor can solve the increased volume, but the aluminum wire generates heat double as much as that of the copper wire, because of the high resistance.

As described above, when the aluminum wire is used, the large number of turns should be wound around the bobbin in comparison with the copper wire, so as to obtain the same current value as that of the copper wire. If a length of the aluminum wire is extended, the resistance value becomes high, and thus, a lot of heat is generated due to the high resistance value. Therefore, it should address the heat generating problem.

Therefore, an object of the present invention is to solve the problems involved in the prior art, and to provide a coil for an electromagnet which can reduce a resistance value when an aluminum wire is used as the coil of the electromagnet.

### Technical Solution

In order to achieve these and other objects, the present invention provides a coil for an electromagnet consisting of a plurality of wires coated with an insulator and wound around a bobbin, in which the wound wires are connected in parallel with each other. Therefore, as compared with the copper wire, although the whole length of the aluminum wires is extended to increase the volume thereof, as the plurality of the aluminum wires are connected in parallel with each other, the resistance value is decreased, and thus, the heat generated from the electromagnet is reduced.

Also, since the aluminum wires not are sequentially wound around the bobbin, but are together wound around the bobbin, the heating value of each aluminum wire is equal, and an amount of heat radiation is also equal. Consequently, there is no temperature variation between the first wire and the second wire, so that the electromagnet can be stably operated.

Consequently, the coil for the electromagnet is characterized in that the coil consists of a plurality of wires coated with an insulator and wound around a bobbin, in which the wound wires are connected in parallel with each other.

The plurality of aluminum wires are in parallel wound around the bobbin.

### ADVANTAGEOUS EFFECTS

A plurality of aluminum wires are wound around the bobbin, and the wound aluminum wires are connected in parallel with each other. Consequently, as compared with the copper wire, although the whole length of the aluminum wires is prolonged to increase the volume thereof, the resistance value is low, and thus, the heating value can be reduced.

Also, since the aluminum wires not are sequentially wound around the bobbin, but are together wound around the bobbin, the heating value of each aluminum wire is equal, and an amount of heat radiation is also equal. Consequently, there is no temperature variation between the first wire and the second wire, so that the electromagnet can be stably operated.

### BRIEF DESCRIPTION OF THE DRAWINGS

The above objects, other features and advantages of the present invention will become more apparent by describing the preferred embodiment thereof with reference to the accompanying drawings, in which:

FIG. 1 is a partially cross-sectional view illustrating the construction of a clutch installed in a compressor.

FIG. 2 is a view illustrating a bobbin wound with a copper wire.

FIG. 3 is a view illustrating a bobbin wound with an aluminum wire according to an embodiment of the present invention.

FIG. 4 is a view illustrating the connection state of first and second aluminum wires wound around a bobbin according to an embodiment of the present invention.

FIG. 5 is a view illustrating a bobbin wound with an aluminum wire according to another embodiment of the present invention.

FIG. 6 is a view illustrating a bobbin wound with an aluminum wire according to another embodiment of the present invention.

FIG. 7 is a cross-sectional view illustrating the connection state of first and second aluminum wires coated with an insulator according to an embodiment of the present invention.

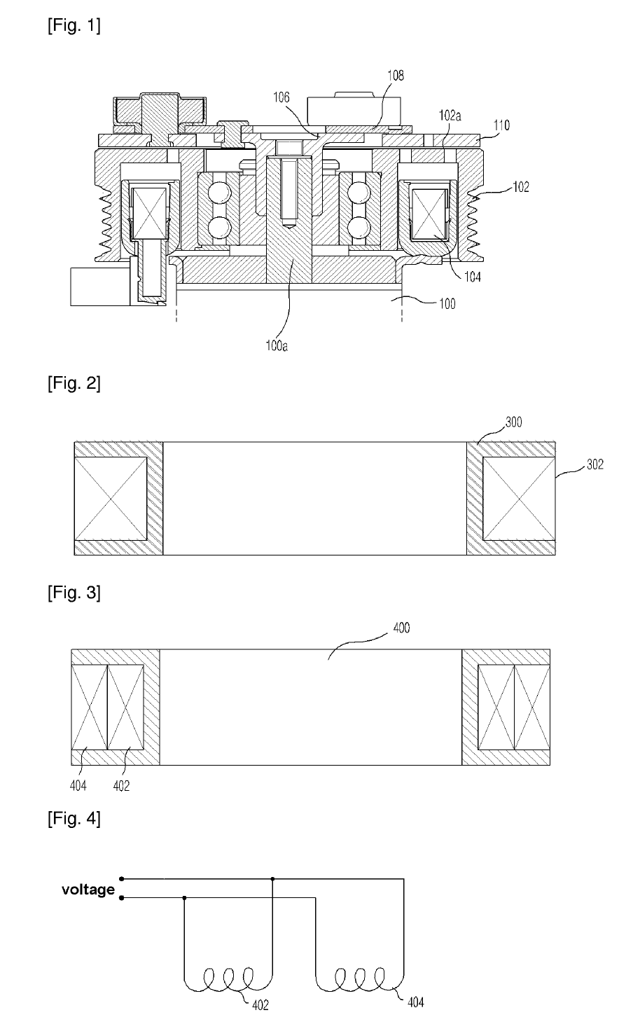

### BEST MODE FOR CARRYING OUT THE INVENTION

Reference will now be made in detail to preferred embodiments of the present invention, examples of which are illustrated in the accompanying drawings.

FIG. 3 is a view illustrating a bobbin wound with an aluminum wire according to an embodiment of the present invention. Reference numeral 400 indicates a bobbin made of plastic which is an insulator. The bobbin 400 includes a first aluminum wire 402 coated with an insulator, such as enamel, wound around the bobbin and a second aluminum wire 404 coated with an insulator, such as enamel, wound around the first wire 402.

As shown in FIG. 4, the first wire 402 is connected in parallel with the the second wire 404.

By sequentially winding the first aluminum wire 402 and the second aluminum wire 404 and connecting the first and second wires 402 and 404 in parallel, the resultant resistance value of the first and second wires 402 and 404 will be decreased, as expressed by Equation 2 below.

$$\frac{1}{R} = \frac{1}{{R}_{1}} + \frac{1}{{R}_{2}} rR = \frac{{R}_{1} {R}_{2}}{{R}_{1} + {R}_{2}} \qquad Equation 2$$

For example, supposing a resistance value of the first and second wires 402 and 404 is equal, if the first wire 402 is connected in parallel with the second wire 404, the resistance value is decreased by ½.

As shown in FIG. 3, if the first wire 402 and the second wire 404 are wound for the same number of turns, the resistance value of the second wire 404 is higher than that of the first wire 402. More specifically, after the first wire 402 is wound around the bobbin 400, the second wire 404 is wound around the first wire 402. If the first wire 402 and the second wire 404 are wound for the same number of turns, a length of the second wire 404 is longer than that of the first wire 402. As a result, the resistance value of the second wire 404 is higher than that of the first wire 402.

In case the electromagnet is driven by applying a voltage to the first wire 402 and the second wire 404, a heating value of the first wire 402 is different from that of the second wire 404, thereby producing a temperature variation. The performance in a saturation state is different from each other, due to the temperature variation. Consequently, the electromagnet is not stably driven.

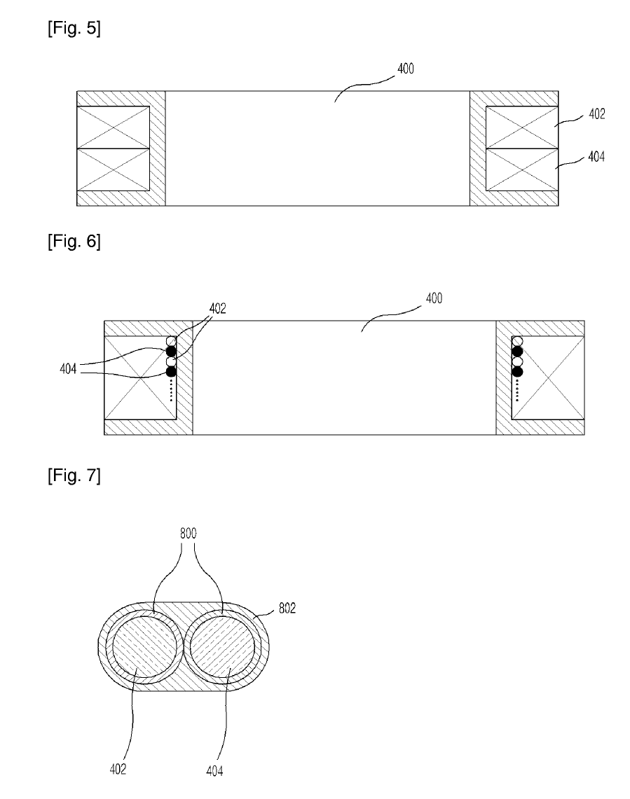

FIG. 5 is a view illustrating a bobbin wound with an aluminum wire according to another embodiment of the present invention. In this embodiment, a region of the bobbin 400 is divided into two parts, and the first aluminum wire 402 and the second aluminum wire 404 which are respectively coated with an insulator, such as enamel, are wound around each part. And then, the wound first and second aluminum wires 402 and 404 are connected in parallel with each other.

In this embodiment, if the first wire 402 and the second wire 404 are wound for the same number of turns, the resistance values of the first and second wires 402 and 404 are equal.

Supposing the first wire 402 is inwardly positioned and the second wire 404 is outwardly positioned, the heat radiation of the first wire 402 inwardly positioned is not good, due to improper air flow, while the heat radiation of the second wire 404 outwardly positioned is good, due to proper air flow.

As a result, a temperature variation happens between the first wire 402 and the second wire 404, and thus, the performance in a saturation state is different from each other, due to the temperature variation, thereby exerting a bad influence on the electromagnet.

FIG. 6 is a view illustrating a bobbin wound with an aluminum wire according to another embodiment of the present invention. In this embodiment, the first aluminum wire 402 and the second aluminum wire are positioned in parallel, and are around the bobbin 400. Both ends of the first wire 402 and the second wire 404 are connected in parallel with each other.

In order to wind the first wire 402 and the second wire 404 around the bobbin 400, the first wire 402 and the second wire 404 are connected in parallel with each other, and then are wound around the bobbin 400.

For example, as shown in FIG. 7, the first aluminum wire 402 and the second aluminum wire 404 which are coated with an insulator 800, such as enamel, are in parallel bound with an insulated coating layer 802, and the bound first and second wires 402 and 404 are wound around the bobbin.

With the construction of this embodiment, since the bobbin is wound with the first aluminum wire 402 and the second aluminum wire 404, the resistance value of the first wire 402 and second wire 404 is equal.

If the voltage is applied to the first wire 402 and the second wire 404 to operate the electromagnet, the heating value of the first wire 402 is identical to that of the second wire 404, and also an amount of heat radiation is equal.

There is no temperature variation between the first wire 402 and the second wire 404, so that the electromagnet is stably operated.

Although winding only the first and second aluminum wires 402 and 404 around the bobbin 400 is described herein, two or more wires can be wound around the bobbin 400, in which the wires are connected in parallel with each other.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

With the above description, a plurality of aluminum wires are wound around the bobbin, and the wound aluminum wires are connected in parallel with each other. Consequently, as compared with the copper wire, although the whole length of the aluminum wires is prolonged to increase the volume thereof, the resistance value is low, and thus, the heating value can be reduced.

Also, since the aluminum wires not are sequentially wound around the bobbin, but are together wound around the bobbin, the heating value of each aluminum wire is equal, and an amount of heat radiation is also equal. Consequently, there is no temperature variation between the first wire and the second wire, so that the electromagnet can be stably operated.

1. A coil for an electromagnet consisting of a plurality of wired coated with an insulator and wound around a bobbin, in which the wound wired are connected in parallel with each other.

2. The coil as claimed in claim 1, wherein the plurality of wired are simultaneously wound around the bobbin.

3. The coil as claimed in claim 1, wherein the plurality of wires are made of aluminum.

4. The coil as claimed in claim 1, wherein the plurality of wires are bound in parallel by an insulated coating layer.

5. A coil for an electromagnet consisting of a plurality of aluminum wires coated with an insulator and wound around a bobbin, and the wound wires are connected in parallel with each other.

6. The coil as claimed in claim 5, wherein the plurality of wires are bound in parallel by an insulated coating layer.
